(19) United States
(12) Patent Application Publication
(10) Pub. No.: US 2010/0242767 A1
(43) Pub. Date: Sep. 30, 2010

(54) PRINTING SYSTEM

(76) Inventor: Horst-Walter Hauer, Wurzburg (DE)

Correspondence Address: QUARLES & BRADY LLP, 411 E. WISCONSIN AVENUE, SUITE 2040, MILWAUKEE, WI, 53202-4497, US

(21) Appl. No.: 12/745,847

(22) PCT Filed: Nov. 27, 2008
(86) PCT No.: PCT/DE08/01961

§ 371 Date: Jun. 2, 2010

(30) Foreign Application Priority Data
Dec. 4, 2007 (DE) 10 2007 058 650.9

(51) Int. Cl. B41F 1/34; B65G 37/00; B65H 19/12

(52) U.S. Cl. 101/480; 414/787; 414/589; 242/559

(57) ABSTRACT

The present invention relates to a printing system, comprising a print material inlet, where non-imprinted print materials can be supplied to the printing system, and a printed product outlet, where printed products can be conveyed out of the printing system, and comprising at least one printing couple (19, 251) or printing tower in which the print material can be imprinted, and comprising at least one reel changer (18) or sheet feeder for feeding the print material, and comprising at least one unit, particularly a folding unit (22, 255, 256) or sheet delivery, for post-processing and/or removing the printed product, wherein the printing system comprises at least two system levels arranged vertically above each other, and wherein the printing system forms at least one material flow line (12) along which the print material is conveyed through the printing system, wherein in addition to the printing system a transport system is provided which extends parallel to the material flow line across the entire length of the printing system, wherein the transport system comprises at least one conveyor device (33, 35, 39) and at least one transport unit (26, 29, 30, 31, 32, 34, 36, 141, 142, 151, 161, 191, 202, 221), and wherein the conveyor device (33, 35, 39) can be horizontally displaced in parallel to the material flow line (12), and wherein the transport unit (26, 29, 30, 31, 32, 34, 36, 141, 142, 151, 161, 191, 202, 221) can be raised vertically to any of the system levels by driving the conveyor device (33, 35, 39).

The present invention relates to a printing system according to the preamble of claim 1.

In generic printing systems for producing printed products all components provided starting from the print material inlet up to the printed product outlet are integrated. According to the state of the art, the components of the printing system, comprising a preliminary stage, paper storage, daily storage, printing machine, supply and auxiliary units, further processing and transport system, are separately accommodated in different regions. The components and the units thereof are separately automated. For operation of the printing system, the operators are required to operate the units and to convey production material between the various components of the printing system. In some instances, for conveyance automated transport systems are provided as well. However, said transport systems feature different technical configurations as a function of the components and the transport material, so that a plurality of different interfaces is provided between the various transport systems.

Unloading of the paper reels or pallets containing paper sheets subsequent to delivery, sorting and conveyance out of the paper storage are either performed manually with the aid of a forklift truck or are automated, e.g. via corresponding unloading devices, dumping stations, buffer conveyors or shelf conveyor vehicles. The reels are conveyed manually or else with the aid of a transport unit of below-grade conveyor systems or above-grade conveyor systems for the purpose of unpacking or adhesion preparation, and are subsequently further conveyed to the printing machine. Document DE 39 10 444 A1 and Document DE 37 39 222 A1 describe such printing systems having transport systems for conveying paper reels.

Printing plates are also frequently delivered at a different location and are manually conveyed into the storage and are further conveyed from the storage to the plate production site. From this location, the printing plates are manually carried by the operators using stairs, elevators or auxiliary elevators so as to be placed in front of the individual printing stations and are manually mounted on the impression cylinder or are placed into the plate storage container of an automation unit installed at the printing unit. In the automation unit, the plates are then automatically mounted on the impression cylinder. Transport up to the printing station and to the storage container is carried out in an automated manner with the aid of a plate conveyor system specially provided for this purpose. Document DE 27 04 379 C2 describes such a conveyor system for transporting printing plates.

The transport of liquid printing material and printing auxiliary material, such as ink, to the intermediate tank system is carried out via pipes or else manually by means of containers. The transport of spare parts is performed manually with the aid of, where appropriate, an indoor crane.

Operation of the printing machine is typically performed in a soundproof and air-conditioned operator room located in a building and having the control centers located therein.

The units of the printing machine are stacked onto a so-called concrete table and are interconnected with the aid of one or several galleries, stairs or elevators. In this way, the various system levels are rendered accessible for the operating personnel. The concrete table fulfils a supporting function for the units of the printing machine and is required to ensure accessibility to the units directly arranged thereon. Moreover, the concrete table needs to be provided with openings for the paper webs and needs to provide sound insulation for the operators in the region below the table.

The individual units of preliminary stage, paper storage, daily storage, printing machine, supply and auxiliary units, further processing and transport systems are each equipped with operating, soundproofing and safety elements. For initial installation and maintenance of the units, temporary or stationary auxiliary cranes are installed as transport units.

It is a drawback of the known printing systems that components are arranged in a spatially separated fashion in different parts of a printing plant and that differently configured transport systems are provided between the components. The various transport systems are each suited for a specific transport material only. The planning and design of the system, and especially the future adaptation or further automation, therefore require considerable expenditure of time and costs.

Moreover, an adverse effect is produced by the aspect that the components constitute spatially and technically separate standalone solutions, the planning and installation, particularly the future adaption and further automation of which require considerable expenditure of time and costs.

The constructional design of the units is additionally determined by security regulations to be observed, such as pass line heights in the form of auxiliary steps, spacer pieces for height adjustment or the like.

The considerable distances and the number of the system levels have a negative impact on the manual transport of for instance printing plates, thereby giving rise to considerable transport times on the part of the operating personnel.

It is true that in the newly introduced compact printing units a reduced number of system levels needs to be provided, for operating, maintaining and cleaning the compact printing units, however, the system levels need to be subjected to a complex mechanical separation process, thereby increasing the costs for the printing units. In the region of the folding unit, several system levels need to be additionally provided, thereby rendering operation in the system setup and in eliminating malfunctions more difficult.

The operators must leave the room provided in the building for stacking the printing units. In the newly introduced compact units, the automation units for stacking need to be loaded even during operation of the printing couple, compelling the operators to wear noise protection means. Moreover, it is a drawback that both in the automation of the stacking process as well as in the automated feeding of paper reels or paper pallets manual operation still needs to be possible to ensure the safety of the production process. Hence, complex safety measures are required both for the manual and for the automated operation of the units.

It is also disadvantageous that in each case one automation unit is allocated for stacking one printing site, thusly requiring a large number of units. Hence, automation units are likewise installed at sites where they are actually inefficient in terms of production.

Moreover, when using a concrete table the long production time thereof also constitutes a drawback. The additional weight, the low flexibility in terms of modifications and upgrades of the printing system as well as the high costs required for production and disposal basically also constitute aspects against the use of concrete tables.

Insofar as a heavy-duty crane is required only for assembly, high additional costs are consequently incurred with respect to the crane and building reinforcement. For the transport of normal materials, the heavy-duty crane usually is not required.

Based on this state of the art it is hence an object of the present invention to suggest a novel printing system with which the drawbacks residing in the known state of the art are overcome.

This object is attained by a printing system according to the teaching of claim 1.

Advantageous embodiments of the present invention are the subject-matter of the subclaims.

The inventive printing system generically integrates all components and units required for imprinting and which are arranged between print material inlet and printed product outlet. Specifically, the printing system comprises at least one printing couple or a printing tower in which the actual printing process is executed. Moreover, at least one reel changer or sheet feeder is provided in order to allow feeding of the print material during roll-fed printing and sheet-fed printing in a definitely sorted manner. Besides, the printing system comprises at least one unit, particularly a folding unit or a sheet delivery, which is suited for post-processing and/or definitely sorted discharge of the printed products subsequent to carrying out the printing process. Moreover, it is a characteristic of generic printing systems that at least two system levels vertically arranged above each other are provided. The printing system as such forms a straight material flow line. Along said material flow line the print material is delivered through the printing system from the print material inlet to the printed product outlet.

In contrast to the hitherto employed combination of manual transport options and various automated transport systems, a transport system is provided for the inventive printing system, which extends in parallel to the material flow line over the entire length of the printing system and which is hence capable of covering all regions of the printing system. Said transport system comprises a conveyor device and at least one transport unit. Said conveyor device is characterized in that it is horizontally displaceable in parallel to the material flow line of the printing system. On its part, the transport unit mounted at the conveyor device can be raised vertically to any of the system levels at the conveyor device. As a result, it is thusly possible to reach and to consequently cover the entire printing system with the aid of the transport unit by means of displacing the conveyor device in a horizontal direction and by displacing the transport unit in a vertical direction. Thus, all transport functions at the printing system can be fulfilled using the inventive transport, system.

The manner in which the conveyor device is constructed is basically optional. According to a preferred embodiment, a conveyor elevator is employed as a conveyor device, wherein the transport unit is attached to the conveyor elevator and can be vertically raised using the conveyor elevator.

An especially accurate positioning and stable conveyance of the conveyor elevator is ensured if the conveyor elevator is displaceable on at least one rail parallel to the material flow line. As a result, a modified rail conveyor system with a vertically raisable transport unit is obtained.

In many instances, a special configuration of the transport unit will be necessary for executing specific transport functions. If for instance paper reels are intended to be conveyed, the transport unit is required to be equipped with a corresponding mandrel which can be laterally inserted into the paper tube of the paper reel. Alternatively thereto, a gripper can be provided on the exterior circumference of the reel, or else lateral support strips are arranged underneath the reels. In order to be able to adapt the transport system in a flexible manner to various transport tasks, it is thusly especially advantageous if the transport unit is attached to the conveyor device so as to be exchangeable. In this way, it is rendered possible to optionally attach different exchangeable transport units to the conveyor device and to consequently execute different transport tasks. The various exchangeable transport units may then, for instance in the case of non-use, be stored in an exchangeable transport unit storage and can be retrieved from there, if required, by the conveyor device. In the light of the aspect that the exchangeable transport units are attached to the conveyor device always in the same manner, it is possible to attach the transport unit to the conveyor device with the aid of uniform adapters.

In order to ensure reliable conveyance for instance of heavy materials such as paper reels, an exact relative arrangement between the transport unit and the relevant unit of the printing system is necessary. In order to ensure said exact relative arrangement, a mechanical fixing device by means of which the transport unit can be detachably fixed at the printing system may be provided at the transport unit. After start-up of the corresponding unit of the printing system, the fixing device can be activated, preferably in a remote-controlled fashion, and a mechanical fixation between transport unit and printing system can thereby be created. Subsequently, the corresponding machining task is executed and the fixing device is ultimately detached again. Thereafter, the transport unit can be removed again from the relevant unit in order to execute another transport task.

Insofar as an autonomous electrical supply of the transport unit is not possible, this aspect can be remedied also with the aid of an electrical supply interface. Said electrical supply interface is connected to the electrical supply lines of the printing system after start-up of the corresponding unit of the printing system, so that the transport unit can consequently be supplied with electrical energy from the energy supply network of the printing system.

Besides, the transport unit may also be provided with a data interface in order to be connected to the data lines of the printing system. In this way, data exchange between transport unit and printing system is enabled also in the absence of a wireless data connection.

The type of transport tasks to be executed with the aid of the transport unit of the inventive printing system is basically optional. A first field of application of the transport units is the transportation of personnel, in order to carry operating personnel to the various parts of the printing system. To this end, the transport unit can be configured in the type of a mobile personnel transportation unit. As a consequence, the complex galleries and the interposed stairs which are otherwise required at generic printing systems to reach the different system levels can be dispensed with. For reaching the various regions of the printing system the operating personnel may ascend the personnel transportation unit and may rapidly reach the relevant region of the printing system. This technology, where the operator can be moved, provides entirely new types of operation. It is conceivable that an acute malfunction can be analyzed by expert software to the extent so as to be able to establish whether manual interaction on the part of the operator is necessary. The operator may then instantaneously (upon acknowledgement) be carried to the location of the failure. Another transport unit automatically carries further operators or suitable spare parts to the location of said failure.

The operating system may request the operator to perform an inspection and may carry the operator to the location of the hazard already at the time when a warning is output, i.e. prior to machine standstill.

The operating system may coordinate the setup processes in a temporally optimal manner.

In line with the basic version, the personnel transportation unit is solely intended for transportation of personnel. In upgrading said functionality, the personnel transportation unit, however, may also include an operator cabin, wherein the operator to be carried is protected on all sides by a cabin wall. As a result, by means of the operator cabin a room for the operating personnel is created, providing shelter to the operating personnel from undesired external impacts, especially noise. In this context the dimensions of the operator cabin as a matter of course can be adjusted to different needs, so that it is equally possible to accommodate several operating persons in the operator cabin. Moreover, the operator cabin can be equipped with suitable furniture, especially seating furniture, so as to enhance operating convenience. The cabin wall preferably should also contain transparent sections, for instance safety glass panes, in order to make it possible for the operating personnel to directly inspect the printing system. For executing certain processes or for performing inspections, the operating personnel along with the operator cabin may then be carried to the various locations of the printing system. As far as necessary, the operating personnel may leave the operator cabin at the relevant location and may laterally enter the printing system.

In order to shelter the operating personnel from the undesirable consequences of exposure to noise or temperature, the operator cabin should preferably be designed in a soundproof and/or air-conditioned manner.

In the known printing systems, the various units are respectively equipped with specific operating elements, especially safety operating elements, for instance an emergency turnoff button. Each individual unit hence needs to be equipped with a plurality of operating elements and safety operating elements, thereby giving rise to high costs. In order to reduce said costs, the personnel transportation unit may include corresponding operating elements, especially safety operating elements. Beyond that, provision needs to be made for a data connection via which data can be exchanged between the operating elements of the personnel transportation unit and the functional units of the printing system. In this way, most operating elements arranged at the functional units of the printing system can be dispensed with and can be replaced by the operating elements in the personnel transportation unit, since operation of the functional units anyway can only be performed by the operating personnel respectively located in the personnel transportation unit. Where appropriate, it is also possible to dispense with for instance mechanical safety devices, such as finger protection bars or covers, if the same have once been fixedly installed for a specific unit or else detachably installed for various units. If the operating and safety elements are removed from the units, it is also possible to incorporate other functional elements, for instance position feedback signals from adjusting elements which are otherwise still operated via the unit control can be incorporated. This aspect involves both inputs and outputs (I/O's). The signals can be directly transmitted from the individual adjusting elements in a wireless fashion. Then, the controlling operation in the units can be drastically minimized or else can be completely replaced by the wireless data transmission.

According to another upgrade stage of the inventive printing system in the personnel transportation unit provision is made for a control center for controlling the printing system. In turn, a data connection for data exchange between said mobile control center and the printing system needs to be provided. By means of the control center, the operating personnel located in the personnel transportation unit is provided with the option to control the entire printing system, so that a stationary control room having a fixedly integrated control center can be dispensed with. Said mobile control center thereby provides the advantage that the operating personnel, where required, may directly reach and inspect each location of the printing system.

In this context, it is especially advantageous if a wireless data connection is provided between the mobile control center and the printing system for data exchange. In this way, the control center can be positioned in the personnel transportation unit in a highly flexible manner and regardless of trailing cables. It is conceivable to employ for instance WLAN data networks as wireless data connections.

In addition to personnel transportation, the automation of certain operating processes or delivery processes constitutes an alternative or additional field of application of the transport systems installed on inventive printing systems. To this end, the transport unit which is horizontally and vertically positionable with the aid of the conveyor device can be designed in the type of a mobile automation unit. The operating processes or delivery processes to be respectively executed can then be implemented at the corresponding unit of the printing system, wherein the automation unit is then positioned at another unit, and may execute the relevant processes at this unit. In this way, a plurality of automation units which are otherwise required to be positioned in a stationary manner can be dispensed with and can be replaced by a mobile automation unit.

Specifically such mobile automation units can be employed for assembly and/or disassembly of printing plates at printing systems.

Another field of application for the use of transport units is material supply and material disposal. For this purpose, the transport unit may be configured in the type of a mobile material supply unit or else in the type of a mobile material disposal unit by means of which the respectively required material, for instance paper, ink, spare parts, printing plates, direct mail promotional material, packaging material, stickers, paper tubes or maculation, can be automatically delivered to or delivered away from specific parts of the printing system.

Specifically, a material supply unit for transporting non-imprinted paper reels or non-imprinted paper sheets should be provided to solve said main transport task.

Besides, provision should also be made for a material disposal unit for transporting unloaded paper tubes.

As a matter of course, combined material supply and disposal units, which can be used both for material supply and for material disposal, are also conceivable.

In order to attain enhanced functional integration, transport units may also be configured in the type of combination units, by means of which different functions of various fields of application, especially for carrying operating personnel and/or for transporting material and/or for automatically executing operating processes and/or delivery processes, can be fulfilled.

For many functions it is sufficient if the transport unit is positioned at the desired location of the printing system on a side of the printing system by driving the conveyor device. For some functions, however, said lateral arrangement of the transport unit may be insufficient. For instance when feeding paper reels to a reel changer, the paper reel needs to be laterally driven into the printing system in order to attain central positioning of the paper reel in front of the reel changer. Also in the case of a printing plate change, positioning of the relevant automation unit directly in front of the relevant printing couple is frequently necessary.

In order to enable this, the transport system may be equipped with a transverse drive, by means of which the transport unit can be driven transverse to the material flow line. By driving the transverse drive, the transport unit can thus be laterally driven into the printing system.

In addition to the transport system, the present invention relates to another inventive aspect, i.e. the integration of various components of the printing system into an overlapping support frame. Hence, according to said second inventive aspect it is suggested that the printing system features such an overlapping support frame to which substantially all components of the printing system can be attached along the material flow line starting from the print material inlet up to the printed product outlet. As a consequence, this means that the printing system is no longer assembled in the type of standalone solutions using a large variety of different individual components, thereby giving rise to difficulties as a result of the interfaces between the individual components. Instead, the printing system is integrated into the overlapping support frame. By using such an overlapping support frame, the production of a concrete table for setting up the printing system can be dispensed with. Moreover, the use of such a support frame enables highly flexible rearrangement of units and components in a reconfiguration of the printing system, if for instance product requirements have changed or in the event of technical innovations or upgrades.

The constructional design of the support frame is basically optional. According to a preferred embodiment, several modular cells, in which respectively one functional module of the printing system, for instance a printing couple, a folding unit, a reel changer or the like, can be accommodated, are formed by the support frame. Said individual modular cells are horizontally arranged side-by-side along the material flow line and are arranged above each other at various system levels. As a result, the individual modular cells form open or closed spaces in which respectively one functional module can be accommodated. This enables the use of a large number of identical parts, since the functional modules can be designed in the type of standardized components in serial production.

The type of the functional modules used and arranged in the individual modular cells is basically optional. Preferably, one functional module designed in the type of a printing couple, printing roll or dryer or material storage or cooling roll unit or reel changer or sheet feeder or folding unit or operator room should be arranged in at least one modular cell. The individual functional modules may in this context be prefabricated by the manufacturer and can be readily mounted during use of the printing system by arrangement in a modular cell. Specifically, easy dismantling of the printing system is conceivable. Moreover, the individual functional modules can be readily reused at a later point of time and can be employed at a different location in a modified system configuration.

For arrangement of the functional modules in the modular cells of the support frame two alternatives are available, respectively depending upon the alignment of the rolls and cylinders. According to the first alternative, the longitudinal axes of the rolls and cylinders of the functional modules extend transverse to the direction of the material flow line. As a consequence, a highly compact construction is attained, since the rolls and cylinders over their entire length extend transverse to the printing system.

According to the second alternative, the longitudinal axes of the rolls and cylinders of the functional modules extend in the direction of the material flow line. It is true that thereby the length of the printing system tends to be extended in the direction of the material flow line, the arrangement of the longitudinal axes of the rolls and cylinders in the direction of the material flow line, however, provides the advantage that the rolls and cylinders are laterally accessible from the printing system, and hence are accessible from the transport unit. Thus, specifically maintenance and inspection of the printing system are simplified.

In order to be able to dispense with a heavy-duty crane during assembly of the printing system, the conveyor device of the transport unit can be employed. Instead of the transport units typically attached to the conveyor device, during assembly of the printing system respectively one functional module is accommodated at the conveyor device and is conveyed to the correspondingly provided modular cell of the support frame. At this location, the functional module can be laterally inserted into the modular cell, for instance by driving the transverse drive, and can be attached therein. One conveyor device on its own is limited in terms of the lifting force. However, if it is possible to electrically and/or mechanically couple two or else four conveyor devices, the lifting force is increased to an extent which is sufficient for raising the light-weight units of the subsequent concept stages.

It is especially advantageous if the dimensions of the modular cells correspond to the preset modular dimensions, since as a consequence the use of a plurality of identical parts can be simplified. Moreover, the printing system can also be readily upgraded at a later stage by adding further raster elements.

The individual modular cells on their part preferably should be designed with a cubical shape and should each feature a uniform width corresponding to the width of the printing system transverse to the material flow line. Hence, the printing system is formed by stacking a plurality of modular cells which are successively arranged in the direction of the material flow line.

In order to enable standardized supply of the modular cells with energy, water and information, the modular cells preferably should feature connections for supplying the functional modules with electrical energy and/or water and/or pressurized air and/or data.

In order to readily enable material flow between the modular cells, paper conveyance devices may respectively be provided between two modular cells.

Constructively speaking, the support frame may be designed in a simple manner by a plurality of longitudinal supports which are interconnected at points of intersection. For instance a support frame can be composed of standardized steel beams and at a later stage can be equipped with the corresponding functional modules for the purpose of assembling the printing system.

Various aspects of the present invention are schematically illustrated in the drawings and are exemplarily specified below.

In the drawings:

FIG. 1 illustrates a first embodiment of an inventive printing system in a lateral view;

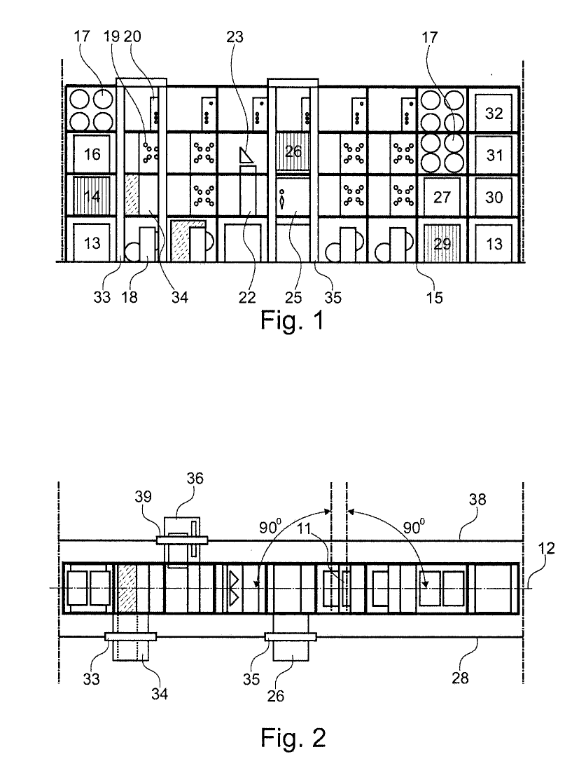

FIG. 2 illustrates the printing system according to FIG. 1 in a plan view;

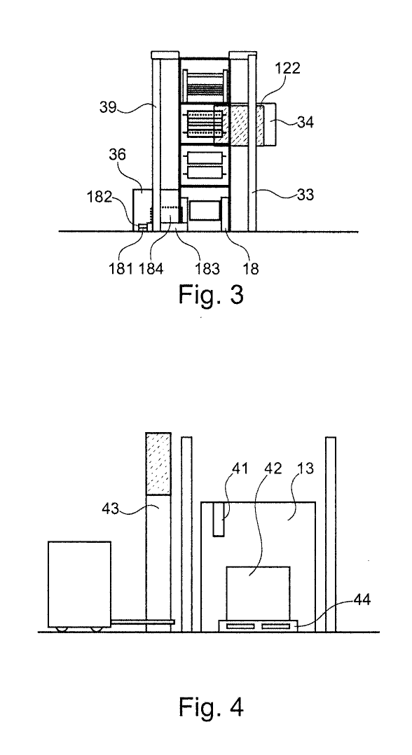

FIG. 3 illustrates the printing system according to FIG. 1 in a cross-sectional view;

FIG. 4 illustrates a first functional module of the printing system according to FIG. 1;

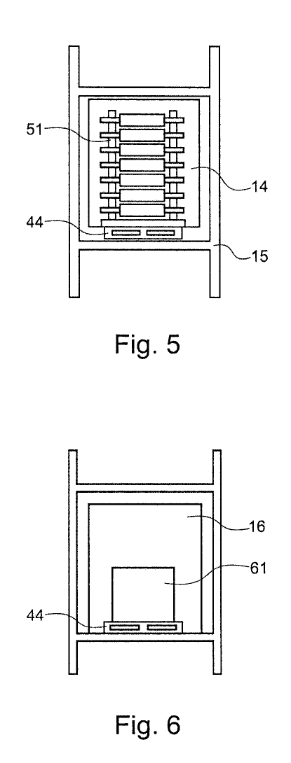

FIG. 5 illustrates a second functional module of the printing system according to FIG. 1;

FIG. 6 illustrates a third functional module of the printing system according to FIG. 1;

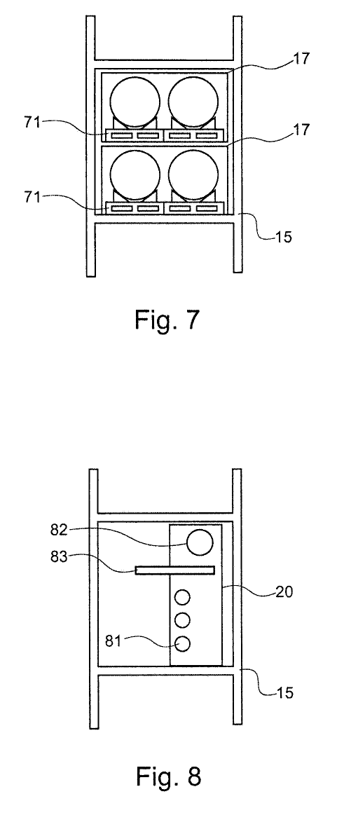

FIG. 7 illustrates a fourth functional module of the printing system according to FIG. 1;

FIG. 8 illustrates a fifth functional module of the printing system according to FIG. 1;

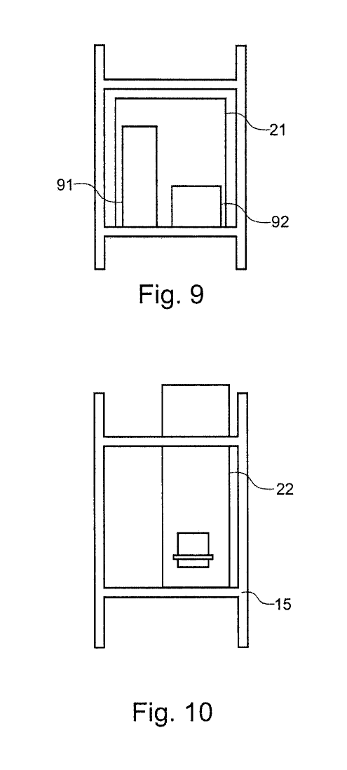

FIG. 9 illustrates a sixth functional module of the printing system according to FIG. 1;

FIG. 10 illustrates a seventh functional module of the printing system according to FIG. 1;

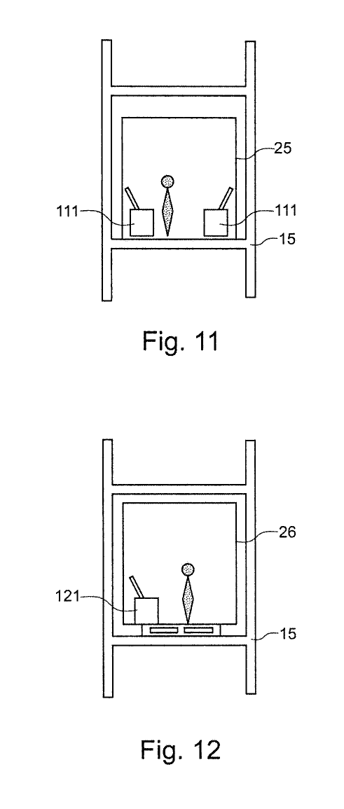

FIG. 11 illustrates an eighth functional module of the printing system according to FIG. 1;

FIG. 12 illustrates a ninth functional module of the printing system according to FIG. 1;

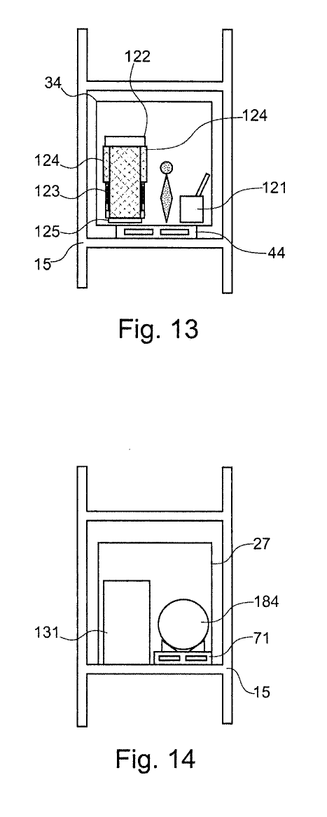

FIG. 13 illustrates a tenth functional module of the printing system according to FIG. 1;

FIG. 14 illustrates an eleventh functional module of the printing system according to FIG. 1;

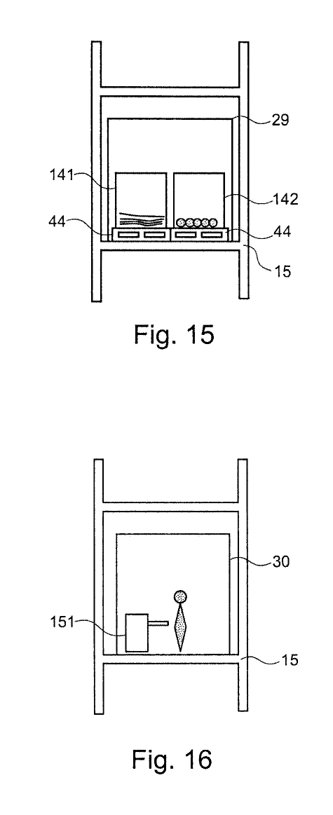

FIG. 15 illustrates a twelfth functional module of the printing system according to FIG. 1;

FIG. 16 illustrates a thirteenth functional module of the printing system according to FIG. 1;

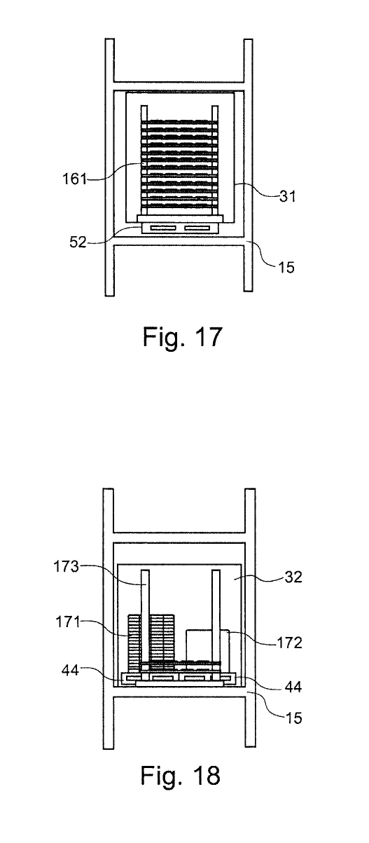

FIG. 17 illustrates a fourteenth functional module of the printing system according to FIG. 1;

FIG. 18 illustrates a fifteenth functional module of the printing system according to FIG. 1;

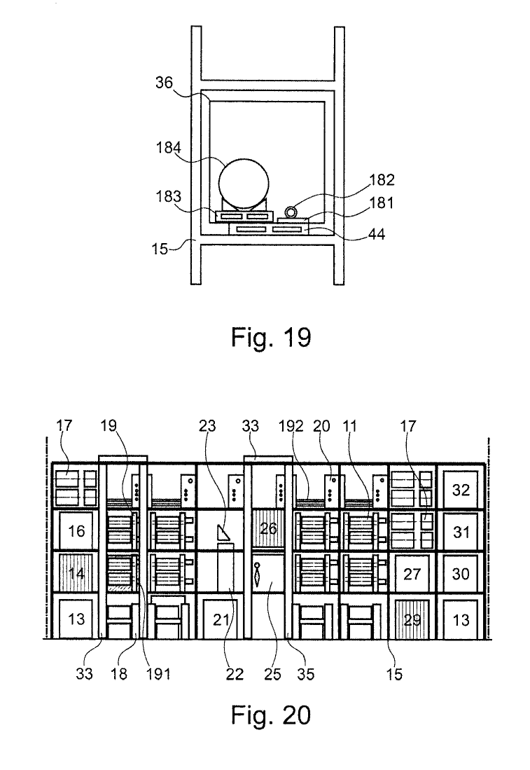

FIG. 19 illustrates a sixteenth functional module of the printing system according to FIG. 1;

FIG. 20 illustrates a second embodiment of an inventive printing system in a lateral view;

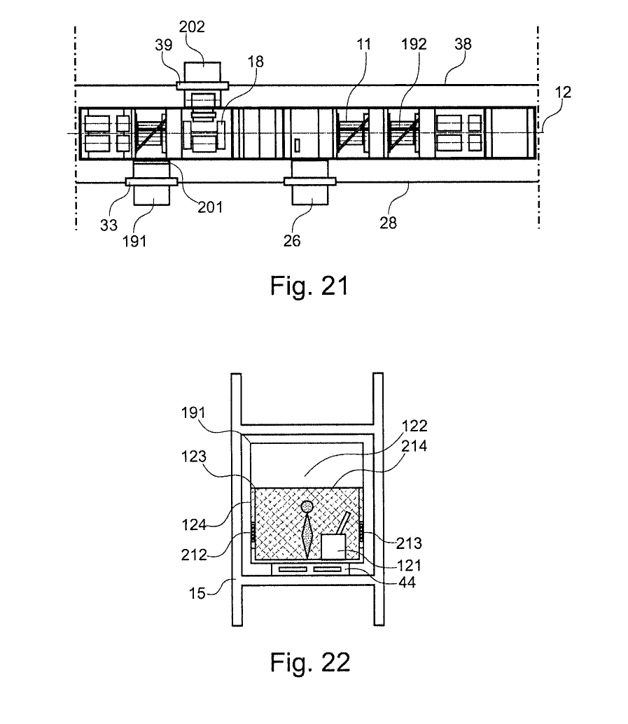

FIG. 21 illustrates the printing system according to FIG. 20 in a plan view;

FIG. 22 illustrates a functional module of the printing system according to FIG. 20;

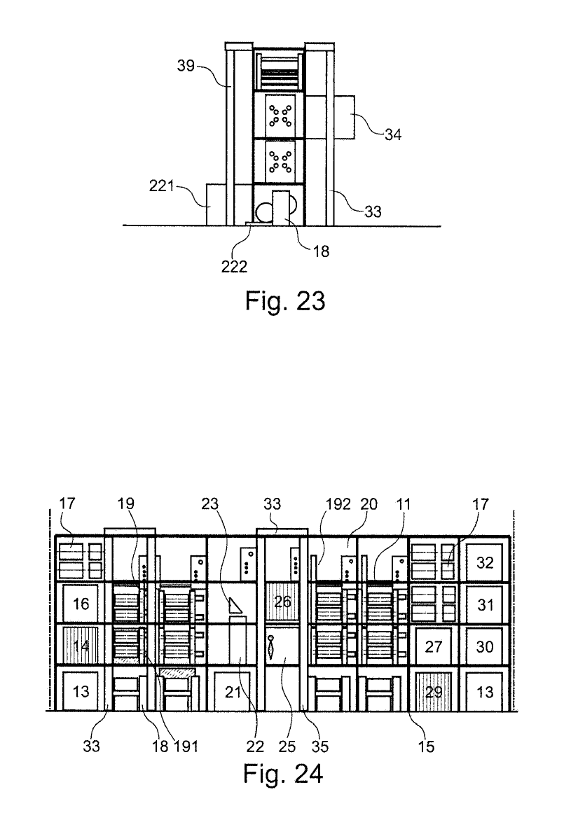

FIG. 23 illustrates the printing system according to FIG. 20 in a cross-sectional view;

FIG. 24 illustrates a third embodiment of an inventive printing system in a lateral view;

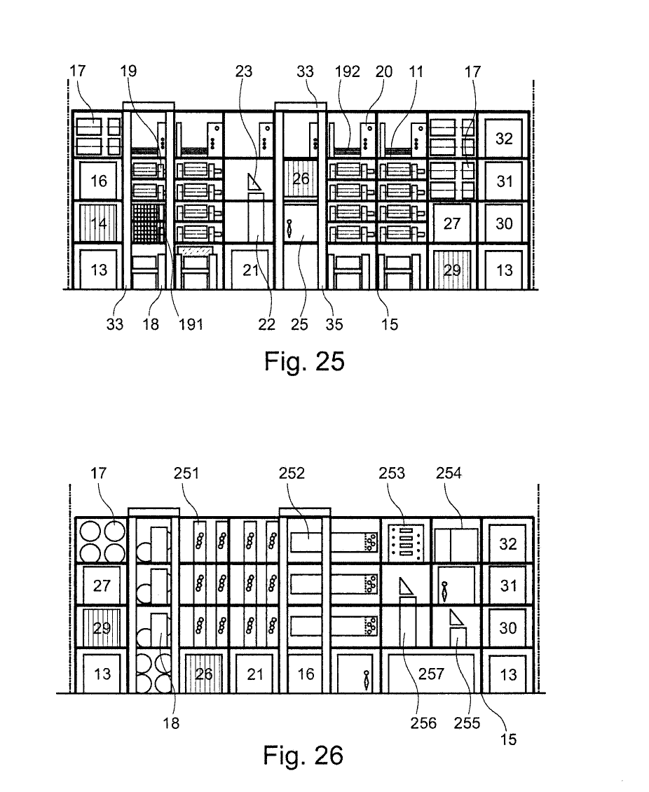

FIG. 25 illustrates a fourth embodiment of an inventive printing system in a lateral view;

FIG. 26 illustrates a fifth embodiment of an inventive printing system in a lateral view;

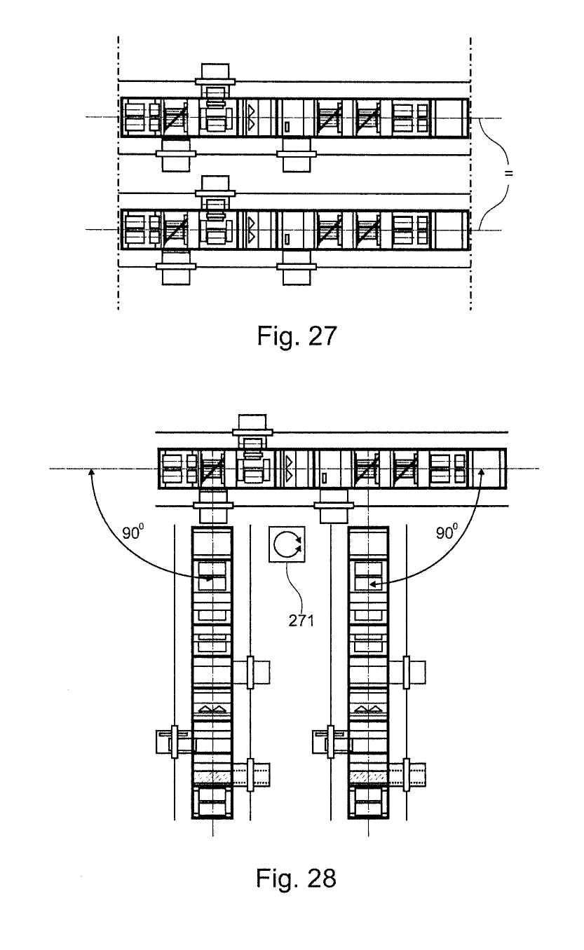

FIG. 27 illustrates a sixth embodiment of an inventive printing system in a plan view;

FIG. 28 illustrates a seventh embodiment of an inventive printing system in a plan view;

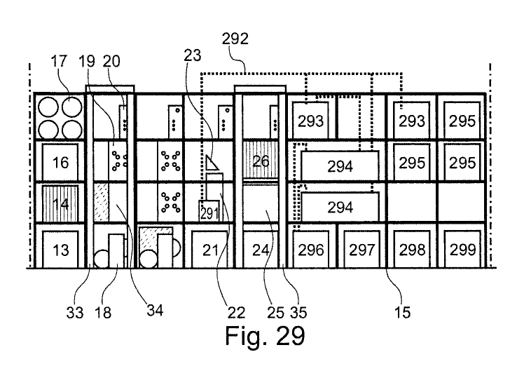

FIG. 29 illustrates an eighth embodiment of an inventive printing system in a lateral view.

FIG. 1 illustrates a first embodiment of a printing system for producing newspapers and magazines with the aid of reel changers 18 and printing units 19. The axes of the impression cylinders 11 vertically extend to the material flow line 12 of the printing system.

FIG. 1 illustrates the printing system in a lateral view. All functional units of the printing system are installed in a support frame 15. The support frame 15 here comprises starting from the left-hand side a building interface 13, a mobile material supply unit 14, a material storage 16, a paper storage 17, a vertical paper conveyance with reel changer 18, two H printing units 19, a superstructure element 20, a second vertical paper conveyance, a unit for auxiliary units 21, a folding unit 22, folding unit superstructures 23, a control 24, an operator room 25, a mobile personnel transportation unit 26, a mobile material supply unit 29, an adhesion preparation unit 27, a printing plate production unit 30, an automation unit 31 and a combination unit (printing plate storage/plate unpacker) 32. Moreover, a conveyor device 33 is provided which is designed in the type of a conveyor elevator. At the conveyor device 33 a combination unit 34 is mounted, which constitutes a combination of operating unit and automation unit. A second conveyor device 35 having a mobile personnel transportation unit 26 is mounted on the same side of the printing system next to the first conveyor device 33.

FIG. 2 illustrates the printing system in a plan view. In this example, the printing system features a first transport rail 28 for horizontal guidance of the conveyor devices 33 and 35 and a second transport rail 38 for horizontal guidance of another conveyor device 39. In this context, at the third conveyor device 39 a mobile material supply unit 36 is mounted. As a matter of course, further conveyor devices each having correspondingly adapted transport units can also be provided on transport rails 28 and 38. On both sides, it is equally conceivable to provide further transport rails in parallel to the illustrated transport rails 28 and 38 in order to thusly appropriately upgrade the system and, where appropriate, to enable exchange of different conveyor devices. Besides, transport rails extending vertically to the material flow line 12 and having conveyor devices which connect two adjacently arranged printing systems are equally conceivable. Instead of the transport rails, other systems for horizontal guidance of the conveyor devices can equally be employed.

FIG. 3 illustrates the printing system according to FIG. 1 in a cross-sectional view. The conveyor devices 33 and 39 having the mobile combination units 24 and 122 and having the mobile material supply unit 36 are apparent. The mobile material supply unit 36 can be laterally driven into the printing system with the aid of a transverse drive 181 in order to thusly convey residual paper reels 182 away from the reel changer 18. With the aid of the transverse drive 183, new paper reels 184 can be placed in front of the reel changer 18. The mobile combination units 34 and 122 each feature an operating unit and a transverse drive, making it possible for the operating personnel to laterally drive in front of the printing couple and to thereby enable operation of the printing couple. FIG. 4 shows a functional module, i.e. the building interface 13, in an enlarged view. The building interface 13 is located in the vicinity of a building opening 43. This opening is opened and closed both for the purpose of material supply as well as for the purpose of production waste disposal. An adapter 44 conveys the material 42. A material scanner 41 monitors all operations and communicates these processes to the material planning system.

The mobile material supply unit 14 illustrated in FIG. 5 comprises a retaining device 51 for mounting of the ink reels. The entire material supply unit 14 having the retaining device 51 and the ink reels can be accommodated by the conveyor device via an adapter 44 and can be conveyed to any optional unit of the printing system.

The material storage 16 illustrated in FIG. 6 serves the purpose of storing maintenance, production and operating means. An adapter 44 which can be connected to the conveyance device conveys the material 61.

FIG. 7 illustrates a paper storage 17 which serves as a daily storage for the production or alternatively as a storage for still packed reels. The prepared paper reels 71 are either directly mounted on respectively one adapter 44 for the conveyor device or else are directly conveyed.

FIG. 8 illustrates a superstructure element 20 which serves for conveying the paper from the printing couple to the folding inlet. This element contains guide rolls 81, turning devices 83 and pull rolls 82.

FIG. 9 illustrates a functional module for an auxiliary unit 21, wherein a compressor 91 and a cooling unit 92 are positioned. FIG. 10 shows the integration of the folding unit 22 and the driving options at the left-hand side next to the unit for operation.

FIG. 11 illustrates the soundproof and air-conditioned operator room 25 having several control centers 111.

FIG. 12 illustrates a mobile, soundproof and air-conditioned personnel transportation unit 26 which is equipped with a control center 121 for controlling the printing system. By means of an adapter 44 the personnel transportation unit which is configured in the type of an operator cabin can be connected to the conveyor devices and can be conveyed to any location of the printing system.

FIG. 13 illustrates a mobile, soundproof and air-conditioned personnel transportation unit 34 which can equally be connected to the conveyor device by means of an adapter 44. The personnel transportation unit 34 is additionally equipped with a control center 121 for controlling the printing system and can be laterally driven into the printing system with the aid of a transverse drive 122. In this way, it is possible to position the operator in the support frame 15 of the printing system. In the personnel transportation unit 34 all operating elements 123 which are required for operating the various units and functional parts of the printing system are located.

Moreover, the personnel transportation unit contains safety operating elements 124, for instance emergency turnoff buttons, for protection of the operators. The transverse drive 122 is displaceable by driving a motor of a driving device 125. The electrical connection of the operating elements 123 and safety operating elements 24 is performed with the aid of trailing cables. Alternatively thereto, wirelessly functioning data connections or contacts, which are only contacted when the personnel transportation unit 34 is coupled to the printing system, can also be utilized.

FIG. 14 illustrates a functional module with an adhesion preparation unit 27. Here, the paper reels 184 are automatically unpacked and furnished with an adhesive, in order to thusly enable automated reel change. This is performed with the aid of an adhesion preparation machine 131. The paper reels are connected to the conveyor devices via an adapter 132 and are conveyed to the corresponding position of the printing system. Disposal of the packaging is performed into the mobile material disposal unit 29 which is arranged below the adhesion preparation unit 27.

FIG. 15 illustrates a mobile material supply unit 29 with a packaging paper container 141 and a container for residual paper tubes 142, both being arranged on a common adapter 44 and hence both being connectable to a conveyor device. If containers 141 and 142 are loaded, disposal via the building interface 13, which at the same time serves as material disposal interface, is initiated via the material planning system.

FIG. 16 illustrates a printing plate production unit 16. In the printing plate production unit 16, the plate production machine 151 is located. The printing plate production unit 30 can be designed in such a manner that the operator manually loads unprocessed plates into the plate production machine 151 and again picks up the finished plates. Here, supply and disposal are executed via a mobile personnel transportation unit 26 which is driven along with the operator by means of the conveyor device. Alternatively thereto, it is also possible to arrange for automatic execution of supply and disposal via automation unit 31.

FIG. 17 illustrates a mobile automation unit 31 having an automation unit 161 in order to automate conveyance of the printing plates. By means of this measure, it is possible to convey printing plates to the printing plate production unit 30, to the printing units and to the combination element 32 and to other mobile material supply units and material disposal units, e.g. for disposal via a building interface.

FIG. 18 as an example illustrates a combination unit 32 serving at the same time as material storage and automation unit. Against the background, a material storage 171 for packed unprocessed plates and a material disposal unit 172 for disposal of the packaging material of the unprocessed plates are illustrated. The material storage 171 and the material disposal unit 172 are each arranged on respectively one adapter 44 in order to be thusly capable of establishing a connection to any one of the conveyor devices. To the fore, the automation unit 173 is illustrated which retrieves and unpacks the packed unprocessed plates from the material storage unit 171, disposes the packaging into the material disposal unit 171 and places the plates into the outlet.

FIG. 19 illustrates the lateral view of a mobile material supply unit 36 in an exemplary fashion. The material supply unit is equipped with two transverse drives 181 and 183. The transverse drive 181 automatically retrieves the residual paper reels 182 from the reel changer. The transverse drive 183 serves the purpose of transverse conveyance of the paper reels 184 into the reel changer.

FIG. 20 illustrates a second embodiment of an inventive printing system in a lateral view. The elements of the support frame are identical to those of the first embodiment, however, the material flow line 12 is configured in parallel to the center axis of the impression cylinders 11 and in parallel to the center axis of the paper reels in the reel changer. The superstructure element 20 contains a full-width turning device 191 for the paper web above the printing unit in order to turn the rolling direction of the paper web by 90°. Moreover, the mobile personnel transportation unit 191 is not equipped with a transverse drive, since the printing couples are directly accessible in front of the printing system when the personnel transportation unit 191 is laterally positioned.

FIG. 21 illustrates the printing system according to FIG. 20 in a plan view. It is apparent from this figure that the mobile personnel transportation unit 191 can be directly positioned in front of the printing couple. For this reason, all safety operating elements 201 are directly installed in the personnel transportation unit 191. The mobile material supply units 202 likewise can be directly positioned in front of the reel changers 18. The mobile material supply unit 202 is equipped with a transverse drive and can be driven into the support frame in order to retrieve residual paper reels and to deliver new paper reels up to the site where they can be picked up by the reel changer 18.

FIG. 22 illustrates a soundproof and air-conditioned personnel transportation unit 191 with an adapter 44 for connection to a conveyor device in a lateral view. The personnel transportation unit 191 is additionally equipped with a control center 121 for controlling the system and is equipped with operating elements 212 and 213 which are required for operating specific units. The safety operating elements 214 for protection of the operator are equally installed in the personnel transportation unit 191. The electrical connection of the operating elements 212 and 213 and of the safety operating elements 214 is performed with the aid of trailing cables and/or in a permanent wireless fashion. Alternatively, provision can also be made for contacts which are contacted only when the personnel transportation unit 191 is coupled to the printing system.

FIG. 23 illustrates the printing system according to FIG. 20 in a cross-sectional view. From this figure, the combination unit 34 is apparent, which can be directly positioned in front of the printing system. The mobile material supply unit 221 is equipped with a transverse drive 222 which loads and unloads the reel changer 18.

FIG. 24 illustrates another embodiment of an inventive printing system. The printing system here largely corresponds to the second embodiment. In this embodiment of the printing system this also means that the material flow line 12 of the printing system extends in parallel to the center axes of the impression cylinders and in parallel to the center axes of the paper reels clamped in the reel changers. Printing couples and superstructures are arranged in the form of stacked units in the support frame. The safety devices and operating elements of the printing towers and superstructures are likewise integrated in the mobile transport units.

FIG. 25 illustrates a fourth embodiment of an inventive printing system in a lateral view. Here, the printing couples are configured as face printing couples or reverse printing couples and are respectively arranged in individual modular cells.

FIG. 26 illustrates a fifth embodiment of an inventive printing system in a lateral view. Here, three horizontal paper conveyance devices with reel changer 18, a total of respectively 4 I printing couples 251 and dryer with cooling rolls 252 are arranged above each other in the support frame. Moreover, a possible position for supplementary devices 253 and, e.g. a flat sheet delivery 254, is illustrated. By the same token, the paper conveyance devices can be flexibly allocated to the folding units 255 and 256. Further processing 257 of the products subsequent to folding delivery has been integrated into the support frame as well.

FIG. 27 illustrates a sixth embodiment of an inventive printing system in a plan view. Here, two support frames are arranged in parallel side-by-side. In this context, the two internally arranged conveyor devices may exchange individual transport units, so that it is possible to exchange the transport units between the printing systems which are arranged in parallel. It is also possible to convey several paper webs side-by-side from one support frame to the next support frame.

FIG. 28 illustrates a seventh embodiment of an inventive printing system in a plan view. Here, two support frames are arranged in parallel side-by-side and a third support frame is arranged vertically thereto. It is thereby possible to convey from each support frame several paper webs stacked above each other into the third support frame. Here, it is also possible for the transport units to exchange individual transport units via a turning unit 271.

FIG. 29 illustrates an eighth embodiment of an inventive printing system in a lateral view. Here, the integration of the further processing into the support frame is illustrated in an exemplary fashion. Via a receiving station 291, the products are either wound in a winding station 293 via a shingle stream system or a cycle conveyor system 292 and can be conveyed via the transport system and a transport unit for winding reels 290 into a storage for unloaded and loaded storage winding reels 295 or can be further processed via the insertion drum 294 or can be conveyed into a packetizing unit/packet delivery 296. From this location, the product packets are conveyed to the combined control and addressing unit having the building interface 299 via the strapping unit 297 and the packaging unit 198.

### LIST OF REFERENCE NUMERALS

11 Impression cylinder
12 Material flow line
13 Building interface
14 Mobile material supply unit
15 Support frame
16 Material storage
17 Paper storage
18 Reel changer
19 H printing unit
20 Superstructure element
21 Auxiliary unit
22 Folding unit
23 Folding unit superstructure
24 Control
25 Operator room
26 Mobile personnel transportation unit with control center
27 Adhesion preparation unit
28 Rail
29 Mobile material supply unit
30 Printing plate production unit
31 Automation unit
32 Combination unit (printing plate storage/plate unpacker)
33 Conveyor device
34 Combination unit (personnel transportation unit/automation unit)
35 Conveyor device
36 Mobile material supply unit
38 Rail
39 Conveyor device
41 Material scanner
42 Material
43 Building opening
44 Adapter
51 Retaining device
61 Material
71 Adapter for paper reels
81 Guide roll
82 Pull roll
83 Turning device
91 Compressor
92 Cooling unit
111 Control center
121 Control center
122 Transverse drive
123 Operating element
124 Safety operating element
125 Driving device
131 Adhesion preparation machine
141 Material disposal unit (packaging paper)
142 Material disposal unit (residual paper tubes)
151 Plate production machine
161 Automation unit
171 Material storage
172 Material unit
181 Transverse drive
182 Residual paper reel
184 Paper reel
191 Mobile personnel transportation unit
192 Turning device
201 Safety operating element
202 Mobile material supply unit
212 Operating element
213 Operating element
214 Safety operating element
221 Mobile material supply unit
222 Transverse drive
251 I printing couple
252 Dryer with cooling rolls
253 Supplementary device
254 Flat sheet delivery
255 Folding unit
256 Folding unit
257 Further processing
271 Turning unit
290 Transport unit for winding reels
291 Receiving station
292 Shingle stream system or cycle conveyor system
293 Winding station
294 Insertion drum
295 Storage for unloaded and loaded storage winding reels
296 Packetizing unit/packet delivery
297 Strapping and transport unit
298 Packaging unit
299 Combination unit

1. A printing system including a print material inlet, where non-imprinted print material can be supplied to the printing system, a printed product outlet, where printed products can be conveyed out of the printing system, at least one printing couple or printing tower in which the print material can be imprinted, at least one reel changer or sheet feeder for feeding the print material into the print material inlet, at least one unit, particularly a folding unit or sheet delivery for post-processing and/or removing the printed products from the printed product outlet, and at least two system levels arranged vertically above each other, and wherein the printing system forms at least one material flow line along which the print material is conveyed through the printing system, said printing system comprising:
a transport system extending parallel to the material flow line across the entire length of the printing system, wherein the transport system comprises at least one conveyor device and at least one transport unit, and wherein the conveyor device can be horizontally displaced in parallel to the material flow line, and wherein the transport unit can be raised vertically to any of the system levels by driving the conveyor device.

2. The printing system according to claim 1, in which
the conveyor device comprises a linearly displaceable conveyor elevator, wherein the transport unit can be raised vertically at the conveyor elevator.

3. The printing system according to claim 1, in which the conveyor device, especially the conveyor elevator, can be linearly displaced on at least one rail in parallel to the material flow line.

4. The printing system according to claim 1, in which the transport unit can be attached to the conveyor device so as to be exchangeable, especially with the aid of a uniform adapter, so that the different exchangeable transport units are optionally attachable to the conveyor device.

5. The printing system according to claim 1, in which the transport unit features one, especially remote-controllable, mechanical fixing device for detachable mounting of the transport unit to the printing system.

6. The printing system according to claim 1, in which the transport unit features an electrical supply line interface for connecting electrical supply lines of the transport unit to electrical supply lines of the printing system.

7. The printing system according to claim 1, in which the transport unit features a data interface for connecting data lines of the transport unit to data lines of the printing system.

8. The printing system according to claim 1, in which the transport unit is designed in the type of a mobile personnel transportation unit with the aid of which at least one operator can be carried to the various parts of the printing system.

9. The printing system according to claim 8, in which the personnel transportation unit comprises an operator cabin in which the operator to be carried is protected on all sides by a cabin wall.

10. The printing system according to claim 9, in which the operator cabin is designed to be sound-proof and/or air-conditioned.

11. The printing system according to claim 8, in which the personnel transportation unit comprises operating elements, especially safety operating elements for operating individual functional units of the printing system, wherein data can be exchanged between the operating elements of the personnel transportation unit and the functional units of the printing system via a data connection.

12. The printing system according to claim 8, in which the personnel transportation unit comprises a control center for controlling the printing system, wherein data can be exchanged between the mobile control center and the printing system via a data connection.

13. The printing system according to claim 12, in which the data connection at least partially enables wireless data exchange between the mobile control center and the various parts of the printing system.

14. The printing system according to claim 1, in which the transport unit is designed in the type of a mobile automation unit with the aid of which operating processes and/or delivery processes in specific parts of the printing system can be automatically executed.

15. The printing system according to claim 14, in which at least one mobile automation unit is provided for machining, especially for automatic assembly and/or disassembly, of printing plates.

16. The printing system according to claim 1, in which the transport unit is designed in the type of a mobile material supply unit and/or a material disposal unit with the aid of which material can be automatically conveyed to and/or conveyed out of specific parts of the printing system.

17. The printing system according to claim 16, in which at least one material supply unit is provided for transporting non-imprinted paper reels or non-imprinted paper sheets.

18. The printing system according to claim 16, in which at least one material disposal unit is provided for transporting unloaded paper tubes.

19. The printing system according to claim 1, in which at least one transport unit is designed in the type of a combination unit, with the aid of which several functions, especially transportation of operating personnel and/or transport of material and/or automated execution of operating processes and/or delivery processes, can be implemented.

20. The printing system according to claim 1, in which the transport unit is mounted at the conveyor device so as to be displaceable transverse to the material flow line by means of a transverse drive and can be laterally driven into the printing system by driving the transverse drive.

21. The printing system according to claim 1, in which the printing system comprises an overlapping support frame in which substantially all components of the printing system can be fastened along the material flow line.

22. The printing system according to claim 21, in which several modular cells in which respectively one functional module of the printing system can be accommodated are formed by the support frame, wherein the modular cells are horizontally arranged side-by-side along the material flow line and are arranged above each other at the various system levels.

23. The printing system according to claim 22, in which a functional module designed in the type of a printing couple or printing tower or dryer or material storage or cooling roll unit or reel changer or sheet feeder or folding unit or operator room is formed in at least one modular cell.

24. The printing system according to claim 21, in which the longitudinal axes of the rolls and cylinders of the functional modules transversely extend to the direction of the material flow line.

25. The printing system according to claim 21, in which the longitudinal axes of the rolls and cylinders of the functional modules extend in the direction of the material flow line.

26. The printing system according to claim 21, in which the functional modules are accommodated at the conveyor device of the transport unit and can be conveyed to the modular cells by means of the conveyor device or by means of several combined conveyor devices during assembly of the printing system in the support frame.

27. The printing system according to claim 21, in which the dimensions of the modular cells correspond to preset modular dimensions.

28. The printing system according to claim 27, in which the modular cells are formed with a cubical shape and respectively feature a uniform width corresponding to the width of the printing system transverse to the material flow line.

29. The printing system according to claim 21, in which the modular cells are provided with connections for supplying the functional modules with electrical energy and/or water and/or pressurized air and/or data.

30. The printing system according to claim 21, in which a paper conveying device is provided between at least two modular cells.

31. The printing system according to claim 21, in which the support frame is composed of a plurality of transverse beams, especially steel beams, which are interconnected at points of intersection.
